(19) United States
(12) Patent Application Publication
(10) Pub. No.: US 2002/0174422 A1
(43) Pub. Date: Nov. 21, 2002

(54) Software distribution system

(75) Inventors: Marcey L. Kelley, Livermore, CA (US); Lauri A. Dobbs, Livermore, CA (US); Tony Bartoletti, Antioch, CA (US); Scott D. Elko, Oakley, CA (US)

Correspondence Address: Eddie E. Scott, Assistant Laboratory Counsel, Lawrence Livermore National Laboratory, P.O. Box 808, L-703, Livermore, CA, 94551, US

(73) Assignee: The Regents of the University of California

(21) Appl. No.: 09/964,029

(22) Filed: Sep. 26, 2001

Related U.S. Application Data
(60) Provisional application No. 60/236,413, filed on Sep. 28, 2000.

(51) Int. Cl. G06F 9/445

(52) U.S. Cl. 717/178; 717/175; 717/169; 717/173

(57) ABSTRACT

A system to securely install software upgrades and patches includes determining which software upgrades and patches should be applied, collecting the software upgrades and patches from vendors by downloading them from the vendor's ftp sites, and installing the software upgrades and patches. Embodiments of the system include interpreting how much memory and disk space is needed to install the software upgrades; interpreting the operating system type, version and architecture the software upgrades apply to; interpreting dependencies on other layered products; interpreting dependencies on other upgrades or patches, interpreting which files and directories will be affected by the installation of the software upgrades; backing out software upgrades and patches.

### CROSS-REFERENCE TO RELATED APPLICATIONS

This application claims the benefit of U.S. Provisional Application No. 60/236,413, filed Sep. 28, 2000, and entitled “System and Method for Distributing Software,” which is incorporated herein by this reference.

The United States Government has rights in this invention pursuant to Contract No. W-7405-ENG-48 between the United States Department of Energy and the University of California for the operation of Lawrence Livermore National Laboratory.

### BACKGROUND OF THE INVENTION

1. Field of Endeavor

The present invention relates to computer software and in particular to a software distribution system.

2. State of Technology

The abstract of U.S. Pat. No. 4,432,057 issued in February 1984 to Daniell et al. and assigned to International Business Machines Corporation for a method for the dynamic replication of data under distributed system control to control utilization of resources in a multiprocessing, distributed data base system describes a method for dynamic replication of data under distributed system control to control the utilization of resources in a multiprocessing, distributed data base system. Previously, systems providing for data replication at nodes of a multiprocessing, distributed data base system required that a central node maintain control, or that replicated data be synchronized by immediately conforming all copies of an updated data item. By this invention, requests for access to data of a specified currency are permitted and conformation of updated data is selectively deferred by use of a control procedure implemented at each node and utilizing a status and control (SAC) filed at each node which describes that node's view of the status for shared data items at other nodes.

The abstract of U.S. Pat. No. 4,468,728 issued in August 1984 to Wang and assigned to AT&T Bell Laboratories for a data structure and search method for a data base management system describes a data structure and search method for a data base management system. The structure and method allow the locating of a stored record in a massive system in a controlled and small number of mass memory accesses. The data structure is arranged into a plurality of search trees, each defining patent nodes and terminal nodes. The nodes of a tree are hierarchically arranged, and the trees are hierarchically arranged as a whole into levels. The initial search tree and an initial subset of trees, in some cases, are designed to be maintained in a main fast access memory. The remaining trees are kept in mass memory. A plurality of first storage files maintained in the mass memory are associated with terminal nodes of each of the trees except the final trees in the hierarchical structure. Terminating storage files, which are the ultimate repository for information, are associated with terminal nodes of the final trees. An input search parameter is partitioned into a plurality of subparameters, one for each level of search trees. The subparameters are used to search a tree in each level of the data structure until the location of a terminating file is determined.

The abstract of U.S. Pat. No. 4,558,413 issued in December 1985 to Schmidt et al. assigned to Xerox Corporation for a software version management system A software version management system, also called system modeller, provides for automatically collecting and recompiling updated versions of component software objects comprising a software program for operation on a plurality of personal computers coupled together in a distributed software environment via a local area network. The component software objects include the source and binary files for the software program, which stored in various different local and remote storage means through the environment. The component software objects are periodically updated, via a system editor, by various users at their personal computers and then stored in designated storage means. The management system includes models which are also objects. Each of the models is representative of the source versions of a particular component software object and contain object pointers including a unique name of the object, a unique identifier descriptive of the chronological updating of its current version, information as to an object's dependencies on other objects and a pathname representative of the residence storage means of the object. Means are provided in the system editor to notify the management system when any one of the objects is being edited by a user and the management system is responsive to such notification to track the edited objects and alter their respective models to the current version thereof.

The abstract of U.S. Pat. No. 4,714,992 issued December 1987 to Gladney et al. and assigned to International Business Machines Corporation for a communication for version management in a distributed information service describes a distributed processing system network in which at least one node operates as a source location having access to data objects of a database, and at least one other node operates as a replica location storing replicas of data objects from the source location, managing obsolescence of the replicas is performed by having the replica locations submitting requests to the source location for ascertaining obsolescence of data objects. The source location, responsive to a request from a requesting replica location, extracts identifiers of a set of obsolete objects and communicates them to the requesting replica location. Upon receiving the identifiers, the requesting location renders inaccessible those data objects corresponding to the identifiers received. The source location then removes those identifiers that have been communicated to the requesting replica location.

The abstract of U.S. Pat. No. 5,155,847 issued October 1992 to Kirouac et al. and assigned to Minicom Data Corporation for a method and apparatus for updating software at remote locations describes a method and system are provided for updating the software used in remote computer systems from a central computer system. The method includes storing in the central computer system, copies of the software executable used in each remote computer system. When the copies of the software in the central computer system are upgraded, for example, to correct the software, to add new facilities, to change user interfaces, to make cosmetic changes, to improve performance, etc., each change made to the software is monitored and stored. The remote computer systems are permitted access to the central computer system via communication links and the software in the remote computer systems and the corresponding software in the central computer system are compared. All of the changes that have been made to the software at the central computer system which have not been made to the corresponding software at the remote computer system accessing the central computer are detected. The detected changes are then transmitted to the remote computer system and applied to the software therein in order to upgrade the software in the remote computer system. The upgraded software in the remote computer system is examined to ensure that the software has been changed correctly. The method allows the software at the remote computer systems to be upgraded even while the software at the remote site is being used. The system and method also allow the software used in the remote computer systems to be upgraded when the remote computer systems use different versions of the software and allow the software to be upgraded in a variety of hardware environments and operating systems.

The abstract of U.S. Pat. No. 5,581,749 titled, System and Method for Maintaining Codes Among Distributed Databases Using a Global Database, patented Dec. 3, 1996, by K. Omar Hossain and James J. Whyte, assigned to The Dow Chemical Company, provides the following description: “A global code system maintains reference records for multiple transaction processing systems on a central database (called a global code database). A client (i.e., a user or an external application) cannot directly create reference records on a transaction processing system. Instead, the client should request the global codes system to create a reference record. The global code system responds, in real time, by adding the record to the global codes database and by distributing the record to one or more transaction processing systems in real time. Similarly, the client cannot directly update or delete reference records on the transaction processing system. Instead, the client should request the global code system to update or delete the reference record. The global code system responds, in real time, by updating or deleting the reference record on the global codes database and by distributing the update or deletion to the transaction processing systems which had been instructed to create the record. In addition to distributing record creations, updates and deletions to the transaction processing systems, the global code system distributes these operations to one or more shadow code systems. Each shadow code system provides a copy of a subset of the reference records for read-only access by remote application programs.”

The abstract of U.S. Pat. No. 5,919,247 titled, Method for the Distribution of Code and Data Updates, patented Jul. 6, 1999, by Arthur Van Hoff, Jonathan Payne, and Sami Shaio, assigned to Marimba, Inc., provides the following description: “A system and method for distributing software applications and data to many thousands of clients over a network. The applications are called “channels”, the server is called the “transmitter”, and the client is called the “tuner”. The use of channels is based on subscription. The end-user needs to subscribe to channel before it can be executed. When the end-user subscribes to a channel the associated code and data is downloaded to the local hard disk, and once downloaded the channel can be executed many times without requiring further network access. Channels can be updated automatically at regular intervals by the tuner, and as a result the end-user is no longer required to manually install software updates, instead these software and data updates are automatically downloaded and installed in the background. This method of automatic downloading of updates achieves for the client the same result as the broadcast distribution of software over a connection based network, but wherein the client initiates each update request without requiring any special broadcast networking infra structure.”

The abstract of U.S. Pat. No. 6,151,643 for a automatic updating of diverse software products on multiple client computer systems by downloading scanning application to client computer and generating software list on client computer by Chheng et al, patented Nov. 21, 2000, assigned to Networks Associates, Inc., provides the following description, “A system and method update client computers of various end users with software updates for software products installed on the client computers, the software products manufactured by diverse, unrelated software vendors. The system includes a service provider computer system, a number of client computers and software vendor computer systems communicating on a common network. The service provider computer system stores in an update database information about the software updates of the diverse software vendors, identifying the software products for which software updates are available, their location on the network at the various software vendor computer systems, information for identifying in the client computers the software products stored thereon, and information for determining for such products, which have software updates available. Users of the client computers connect to the service provider computer and obtain a current version of portions of the database. The client computer determines that software products stored thereon, and using this information, determines from the database, which products have updates available, based on product name and release information for the installed products. The user selects updates for installation. The selected updates are downloaded from the software vendor computer systems and installed on the client computer. Payment for the software update and the service is mediated by the service provider computer. Authentication of the user ensures only registered users obtain software updates. Authentication of the software updates ensures that the software updates are virus free and uncorrupted. Changes to the client computer during installation are monitored and archived, allowing the updates to be subsequently removed by the user.”

The abstract of U.S. Pat. No. 6,195,432 for software distribution system and software utilization scheme for improving security and user convenience

by Takahashi et al, patented Feb. 27, 2001, assigned to Kabushiki Kaisha Toshiba, provides the following description, “A software distribution system and a software utilization scheme for effectively preventing an illegal copy or a software is difficult while improving a convenience of a user. At a user side, a shared key to be shared between a software provider and a user is stored, where the shared key has a guaranteed correspondence with an ID information regarding a payment of a software fee by the user. Then, a desired software is requested to the software provider, and the desired software is received in an encrypted form from the software provider. The desired software received from the software provider is then decrypted by using the shared key stored at the user side, and the desired software in a decrypted form is utilized at the user side.”

The Introduction of White Paper: Integrating Windows NT and Enterprise Computer Systems Copyright 1997 by Humnmingbird Communications Ltd. provides the following description Microsoft's Windows NT workstation and server platforms have rapidly evolved to become robust and stable business computing solutions for the 90's and beyond. The awesome computing power of today's personal computer desktop, combined with Microsoft's Windows NT, blurs the line between what has been traditionally considered a personal computer and a workstation. Windows NT is well on the way to becoming the enterprise workstation of the future for high-end personal computing, as well as an important workgroup server platform. Windows NT is like a tsunami. Never before has the computer industry witnessed such rapid adoption of new technology. However, the success of Windows NT has created a great deal of chaos and confusion, particularly in the UNIX enterprise marketplace. This has presented a major challenge to network managers and administrators who are integrating Windows NT within the multivendor enterprise internetwork. A leading computer trade publication recently published a quote from a university department head which stated “At this point, trying to forge connectivity between Windows NT networks and large UNIX systems is a kludge beyond belief.” This might be true if one depended solely on Microsoft technology; however, a rich array of third party technology based on open industry standards is currently available. Many of the foundation technologies that enable cross platform integration in enterprise environments have been developed by the UNIX community. Successful coexistence of Windows NT systems in the enterprise internetwork is dependent on the implementation of this rich suite of enabling technologies. (The technologies of the Web were also developed by the “open systems” UNIX community, but although they are operating system and platform independent, at this time they offer limited functionality to enterprise systems managers seeking solutions for integrating Windows NT and legacy systems.) Because today's enterprise internetwork is multivendor, interoperability—the ability to share information between different computer systems—has become a critical requirement for internetworking software. Interoperability is a major issue with Windows NT, and many network managers have been faced with the stark reality that when an NT node is added to the network it only sees other Microsoft nodes, i.e. Netbeui. Compounding this issue is NT's limited support for DNS, and the overall lack of TCP/IP utilities and applications. For example there is no support for one of the world's most powerful and successful multi-vendor internetwork connectivity technologies, the X Window System.

The abstract of a paper titled, Secure Software Distribution System, by Marcey L. Kelley, Lauri A. Dobbs, and Tony Bartoletti, presented at the National Information Systems Security Conference, in Baltimore, Md. Oct. 6 and 7, 1997 includes the following description: “Authenticating and upgrading system software plays a critical role in information security, yet practical tools for assessing and installing software are lacking in today's marketplace. The Secure Software Distribution System (SafePatch) will provide automated analysis, notification, distribution, and installation of security patches and related software to network-based computer systems in a vendor-independent fashion. SafePatch will assist with the authentication of software by comparing the system's objects with the patch's objects. SafePatch will monitor vendor's patch sites to determine when new patches are released and will upgrade system software on target systems automatically.”

The abstract of a paper titled, “SafePatch” by Marcey Kelley and Scott D. Elko Oct. 1, 2000 provides the following information provides automated analysis, distribution and notification of security and Y2K patches on network-based computer systems. The software determines what patches need to be installed. It detects patch deficiencies and distributes needed patches as well as the appropriate installation script to Sun systems that run Solaris 2.5.1 or newer.

A secure software distribution system (SSDS) user manual version 0.5 was prepared May 1998 by Lauri A. Dobbs and Marcey L. Kelley. This manual was available to internal users of the secure software distribution system. SafePatch provides automated analysis, distribution, notification, and installation of security and Y2K patches on network-based computer systems.

The abstract of a paper titled, “Intelligent Multimedia Computer Systems: Emerging Information Resources in the Network Environment” By Charles W Bailey, Jr. Library Hi Tech 8, no. 1 (1990): 29-41 provides the following description. A multimedia computer system is one that can create, import, integrate, store, retrieve, edit, and delete two or more types of media materials in digital form, such as audio, image, full-motion video, and text information. This paper surveys four possible types of multimedia computer systems: hypermedia, multimedia database, multimedia message, and virtual reality systems. The primary focus is on advanced multimedia systems development projects and theoretical efforts that suggest long-term trends in this increasingly important area.

The abstract of a paper titled, “Computer Immune Systems” by Mark Burgess, Centre of Science and Technology, Oslo College, Cort Adelers Gate 30 0254 Oslo, Norway, last modified: Thursday May 28, 1998 provides the following information. Multi-tasking, multi-user computer systems depend on constant attention, usually by humans. This level of attention will not be sustainable in the future as traffic and complexity increases. This paper describes work done at Oslo College on the cfengine autonomous model for system administration and its relevance to the notion of computer immunology.

### SUMMARY OF THE INVENTION

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The use of a personal computer has now become an integral part of the life of users in home and business environments. Computer users expect and, indeed, demand reliable performance of their computers and associated computer programs. In view of these expectations, developers of computer hardware and software strive to design and offer reliable computer systems that operate in a well-defined fashion. For example, if a user of a word processing program enters the appropriate keystroke to open a document, the user expects the program to open the document for operation. If the word processing program fails to operate in the expected manner, then the user can quickly grow frustrated with the program and either seek a remedy from the program provider or abandon future use of the program. Clearly, computer developers and users alike have a vested interest in the reliable performance of a computer system.

The present invention provides a computer-implemented system for secure patch software distribution of software from vendors to client's systems. There is an initial determination of which of vendor's patches have been applied to client's systems. Vendor's patches are then installed on to client's systems. An embodiment of the present invention includes a system that determines which patches should be or should have been applied to a system. Another embodiment of the present invention includes a system for backing out undesirable patches from client's systems. Another embodiment of the present invention includes a system for collecting patches from most vendors by downloading them from the vendor's ftp sites. Another embodiment of the present invention includes a system for interpreting the operating system type. Another embodiment of the present invention includes a system for interpreting the operating system version. Another embodiment of the present invention includes a system for interpreting the operating system architecture the patch applies to. Another embodiment of the present invention includes a system for determining how much memory is needed to install said patch. Another embodiment of the present invention includes a system for determining how dependencies on other layered products affect the installation of a patch. Another embodiment of the present invention includes a system for determining if dependencies on other patches affect the installation of a patch. Another embodiment of the present invention includes a system for determining which files are affected by the installation of a patch. Another embodiment of the present invention includes a system for determining which directories are affected by the installation of a patch.

The present invention provides a system of secure installation of software patches from vendor to client's systems. Embodiments of the present invention include various steps such as the following steps. Determining which patches should be applied to the client's systems. Collecting the patches from the vendors by downloading them from the vendor's ftp sites. Determining which patches should be applied to the client's systems. Collecting the patches from the vendors by downloading them from the vendor's ftp sites. Interpreting how much memory and disk space is needed to install the patches. Interpreting the operating system type, version and architecture the patches apply to. Interpreting dependencies on other layered products. Interpreting which files and directories are affected by the installation of the patches. Interpreting which files and directories are affected by the installation of the patches. Backing out patches that should not have been applied to the clients systems. Installing the patches.

Certain embodiments of the system are known as SafePatch secure distribution software system. This system provides automated analysis, distribution, and notification and installation of security patches on network-based computer systems. SafePatch determines what patches need to be installed. For the patches that are installed, SafePatch checks the permissions and ownership of the files referenced in the patch and ensures that the system software is authentic. SafePatch detects patch deficiencies and distributes needed patches as well as the appropriate installation script to client's systems, and optionally installs those patches.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1 illustrates an embodiment of a system incorporating the present invention.

FIG. 2 illustrates another embodiment of a system incorporating the present invention.

FIG. 3 is a flow chart that illustrates another embodiment of a system incorporating the present invention.

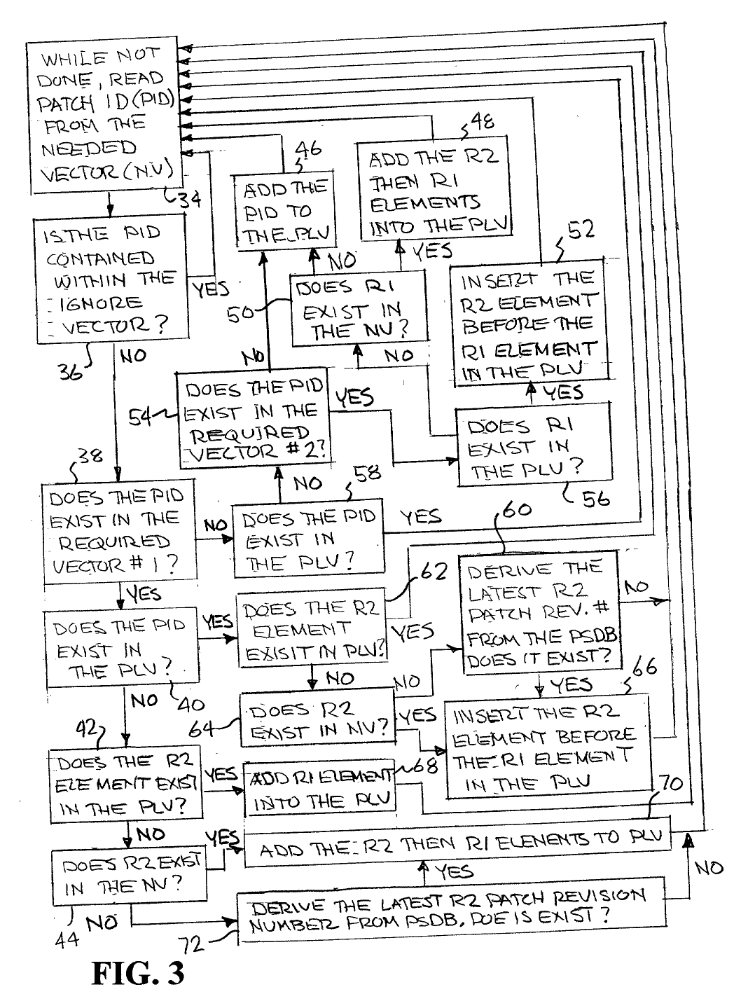

### DETAILED DESCRIPTION OF THE INVENTION

Referring now to the drawings, to the following description, and to incorporated information; a detailed description including specific embodiments of the invention are described. The detailed description of the specific embodiments, together with the general description of the invention, serve to explain the principles of the invention.

System software plays a central role in information security. Most technological methods for securing system resources are dependent upon the system software. Defining access control lists (ACLs), properly setting up user and group accounts, and configuration of network services is useless if the software that is supposed to be enforcing these parameters is not doing what is expected. Short of controlling the physical access to a system, assessing and maintaining the integrity of system software in a networked environment is the first step in information security.

System software is constantly changing, making it difficult to maintain the integrity of the software. Often the system software is security-flawed in the beginning. Major network-wide assaults, such as the notorious 1988 Internet Worm attack, as well as a history of less publicized attacks, exploit these known security flaws to gain illicit access to systems. Vendors are often quick to issue security-patched versions of selected system files. Even when the vendor's issue interim patches to fix the flaws, the new releases of the system software may have overlooked the patches and/or introduced new flaws into the release. This is common in large software companies because the teams that create new releases are often different than the teams that create the interim software patches. This multiplicity of security patches and operating system versions significantly complicates the software authentication effort.

Even if system software was certifiably “clean”, software authentication efforts should also be concerned with the possibility of tampering during episodes of weak security management. A common method of compromising the security of a workstation is to use a foothold on the system (e.g., an unprotected user account) to modify key system files and compromise the system's defenses. Trojan horses are an example of this style of attack.

Vendors are aware of these issues and there is a push toward supplying the customers with “self-installing” patches or similar software installation to assist with the maintenance of software. However, these tools are highly vendor specific and vary wildly in their implementation and effectiveness. The tools applicants have encountered suffer from a common security flaw. These tools attempt to keep track of the patches that they have installed by building a “patch database” file. These tools can be easily fooled into reporting erroneous information because they make no attempt to survey the existing system files using secure cryptographic hashes or even ordinary checksums to ascertain what is actually there. For example, assume a patch to fix vulnerability has been installed using such a tool. Subsequently, an intruder replaces the fixed binary with a Trojan or older flawed version. Using the tool to determine what is installed on the system will indicate that the patch is installed because the tool simply consults the “patch database”. Solutions that rely on a database are unreliable and unacceptable for determining the level of “trust” in operating system software.

Additionally, existing tools do not address the problem of maintenance in a heterogeneous network environment. In an environment where a large mix of vendor systems is employed, the routine maintenance of software versions and interim patches is an administrative nightmare. Learning to operate and manage one vendor's set of software or patch management tools is grueling enough, let alone to do this for all the flavors of UNIX and master their operations manuals. Including other popular operating systems such as Windows NT and MacOS complicates the maintenance task even more. The foregoing examples and other examples known in the art explain why installing patches and upgrades don't get done.

Software management tools are very much needed to support the assessment and authentication of system software on a network as well as installing and upgrading system software. It would be desirable to be able to know exactly which of one's 250 systems are patched up-to-date, which are not, and what patches are needed for each system. Unfortunately, many organizations exist where an administrator of 250 systems could not determine this in a month's time, and certainly not in a manner that involves the actual examination of installed binary files. An embodiment of the present invention enables an administrator to produce this information within hours of the request, from a single console designed to support this type of inquiry and it will do so by actually examining the files present on these systems.

How much trust does a new network administrator place in the computer systems he/she just inherited? How much trust does an administrator place in a network recently experiencing suspicious activity? A responsible alternative to full network-wide system authentication would be to shut the machines down for a full re-install of their operating systems, along with the latest complement of security patches. This represents weeks of service disruption, and the assurances it gives will tend to dwindle with time. More often than not, this simply doesn't get done. Again, this is why a software management tool supporting software authentication is needed.

A software management tool should also support software re-authentication on a regular basis, commensurate in frequency with the value of the resources being maintained on the systems. An embodiment of the present invention provides system administrators with a fast and highly automated method to authenticate system software, determine security patch versions and detect instances of subsequent tampering. In addition, it will provide a convenient and secure means for automating the installation of required security patches and related system software. Information security demands this capability at its foundation.

A software management tool should be capable of collecting patches; determining which patches should be or have been applied to a system; and installing and possibly backing out patches. Patches can be collected from most vendors by downloading them from the vendor's ftp sites. To collect the newest releases, these ftp sites should be monitored regularly.

Once the patches are downloaded to the local system, a software management tool should determine which patches should be or have been applied to a system. This is one of the most difficult tasks to automate in a software management tool. Each patch should be interpreted to determine the operating system type, version and architecture the patch applies to; how much memory and disk space is needed to install the patch; dependencies on other layered products, patches and which files and directories are affected by the installation of a patch. To determine which patches are installed on a system, the files on the system should be compared with files contained in each patch. At present this process is accomplished manually by reviewing the README file associated with each patch.

If the patch is applicable to the system, then the software management tool can install the patch. Installing a patch usually entails following a set of instructions provided with the patch, or executing a script that will install the patch. Sometimes the patch doesn't work as advertised or it interferes with other applications on the system, so the software management tool should also permit patches to be backed-out. Backing-out a patch is similar to installation (i.e., a set of instructions to follow or a script).

The present invention provides a system for secure software distribution including determining which patches have been applied to a system. Determining which patches should be or should have been applied to a system. Collecting patches from the supported vendors by downloading them from the vendor's ftp sites. Interpreting the operating system type, version and architecture the patch applies to; how much memory and disk space is needed to install the patch; dependencies on other layered products, patches, or upgrades; and which files and directories are affected by the installation of a patch. Installing and possibly backing-out the patches.

A serious threat to information resources is the inability to determine and maintain a known level of trust in operating system software. This threat can be minimized if systems are properly configured, use the latest software, and have the recommended security patches installed. However, the time and technique required to assess and install recommended security patches on systems is considerable and too often neglected. This situation is further complicated by the fact that each vendor has his or her own patch distribution and installation process. Some vendors are providing tools to assist with the installation process. However, these solutions, self-installing patches and installation utilities, fail in at least three ways: the target system is not actually examined, their solutions are vendor specific, and they operate on a single host as opposed to a multi-host networked solution.

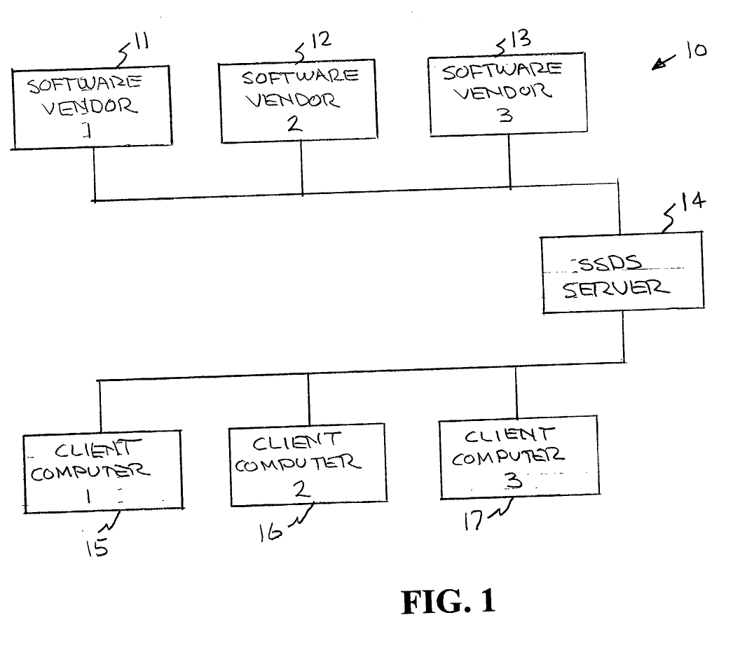

Referring now to the drawings, and in particular to FIG. 1, an illustration of the components of an embodiment of the present invention along with their interaction with the vendor's ftp sites and other network-based computer systems is provided. The embodiment provides secure software by a system capable of determining which patches have been applied to a system. Determining which patches should be or should have been applied to a system. Collecting patches from most vendors by downloading them from the vendor's ftp sites, interpreting the operating system type, version and architecture the patch applies to, how much memory and disk space is needed to install the patch, dependencies on other layered products, patches and which files and directories are affected by the installation of a patch. Installing and possibly backing-out patches.

The embodiment is generally designated by the reference numeral 10. This embodiment will hereinafter be designated “SafePatch.” SafePatch will largely automate the software management tasks described above. It will do this with two major software components: the SafePatch Server and SafePatch Client installed on the target systems. FIG. 1 illustrates these components along with their interaction with the vendor's ftp sites and other network-based computer systems.

Vendor 1, reference numeral 11; vendor 2, reference numeral 12; and vendor 3, reference numeral 13 are shown; however, it is to be understood that an number of vendors can be included. The SafePatch Server 14 monitors the vendor sites for the latest patches and stores them in a non-vendor specific format. The SafePatch Server 14 evaluates target systems on a scheduled basis and installs patches as needed. Client 1, reference numeral 11; client 2, reference numeral 12; and client 3, reference numeral 13 are shown; however, it is to be understood that any number of clients can be included. The System (SafePatch) will provide automated analysis, notification, distribution, and installation of security patches and related software to network-based computer systems in a vendor-independent fashion. This system will allow a network administrator (and users) to query, maintain, and upgrade the software integrity of hundreds of individual systems from a central point through largely automated means. The centralized software system will provide the following services for target systems: rapid system software “trust” determination, automated notification of new vendor security patches, automated determination of patch applicability to target systems, automated installation of security patches and critical system software, ability to “back-out” installed patches, restoring a system's previous state, and collection of site-wide software statistics or metrics on patch status.

The process SafePatch will use to authenticate the software on a system is more reliable and secure than other vendor-specific tools. SafePatch will compare the target system's objects with the objects from the patch to determine what is actually installed and what needs to be installed. This approach ensures accurate reporting of a system's patch status. It also allows SafePatch to identify objects that do not belong to either the original system distribution or to any released patches.

The SafePatch Server software is a central service residing on one computer interacting with a host of network-based computer systems, similar to network-based backup software. The network-based computer systems serviced by the SafePatch Server are referred to as target systems or targets. The SafePatch Server is responsible for monitoring vendor's ftp sites and collecting newly released patches. The SafePatch administrator can specify which vendor sites to monitor and which patches to collect (e.g., security, recommended, all). For instance only Solaris 2.8 security patches can be collected. These patches are then converted to a non-vendor specific, machine-readable format and stored in a database. The process of converting patches will involve some human interaction until the vendors adopt a standard patch format. Patches stored in this format are referred to as patch specifications. A patch specification contains information such as the operating system type, version, and architecture as well as the permissions and ownership for each file and directory manipulated by the patch. A cryptographic checksum for each file is also included in the patch specification to be used for file identification during the evaluation process described later. A patch specification is built for every revision of each collected patch and stored in the patch spec database. By maintaining copies of all patches and all patch revisions, SafePatch can determine what is installed on a system and if it is up-to-date. It is important for SafePatch to collect every revision of a patch because the vendor's ftp sites only provide the latest revision of all patches. Ideally, in the future, vendors will adopt a standard patch format or provide an adjunct for all of their patches (new as well as old patches).

In addition to collecting patches, the SafePatch Server is responsible for evaluating target systems and installing patches on these systems. The system administrators have full control over the scheduling of target evaluations and patch installations. An administrator can request an evaluation immediately or can schedule evaluations on a repeated basis. The SafePatch Server controls the execution of a request by gathering information from the target systems and giving instructions to install and back-out a patch. To evaluate a system, the SafePatch Server asks the SafePatch Client running on the target system what operating system, version, and architecture are running on the target. It then collects all of the patches from the patch spec database pertaining to this system's operating system, version, and architecture. From these patch specifications a list of directories and files manipulated by the patch is formed. The owner, group, permissions, and checksum (for files only) for each file or directory on the list is checked against the owner, group, permissions, and checksums of the respective directory or file on the target system. This check permits the SafePatch Server to determine which patches are actually installed on the target system without relying on the system's local database. From this information, the SafePatch Server can determine which patches need to be installed on the target system in order to bring it up-to-date. The system administrator can choose to have SafePatch install patches immediately after the evaluation or at some later date and time. The system administrator can also choose not to have SafePatch install the patches and instead report on the patches needed. This allows for the system administrators to dictate which actions SafePatch is to perform on a system.

The SafePatch Client software resides on each target in order to respond to the SafePatch Server's commands and requests. SafePatch Client is simple to install, easy to maintain, and uses very few of the target's resources. This is why the majority of the work is done by the centralized SafePatch Server.

Secure communication between the SafePatch Server and the System Client is used to protect data from tampering and eavesdropping and to authenticate services requested. Secure communications employ digital signatures and encryption techniques based on public/private key technology. The SafePatch Server is implemented as a collection of independent processes. These processes also communicate using digital signatures and encryption.

SafePatch can be configured to support most environments because each environment varies in the number and type of systems, as well as the system administration and security policies. SafePatch is easily configured to support both small homogenous networks and large heterogeneous networks.

For an organization with only a few computer systems (e.g., 1 to 50 computers) all of the same type (e.g., Suns) SafePatch would be configured such that the SafePatch Server resides on one computer and the SafePatch Client software would be installed on all of the computers including the computer running the SafePatch Server software. As an example, consider a network of five Sun workstations running Solaris 2.8. One workstation would run the SafePatch Server software. The SafePatch Server would monitor Sun's ftp site for 2.8 patches and collect only these patches. The SafePatch Client software would reside on all five workstations. The SafePatch Server would control the execution of the evaluations and installations based on the schedule determined by the SafePatch administrator or each target's system administrator.

The SafePatch Client software would reside on all five workstations. The SafePatch Server would control the execution of the evaluations and installations based on the schedule determined by the SafePatch administrator or each target's system administrator.

In a more complex environment with hundreds or thousands of systems running a variety of operating systems with different architectures there may be multiple SafePatch Servers in order to service the large number of systems and networks. In a complex environment, the idea of centralizing the SafePatch services is taken one step further. Here one or two computers would be configured to support the patch collection and storage function of the SafePatch Server. This centralized patch collection service may be manned by one or two people to assist with the conversion of patches to the standard patch format until vendors adopt a standard format.

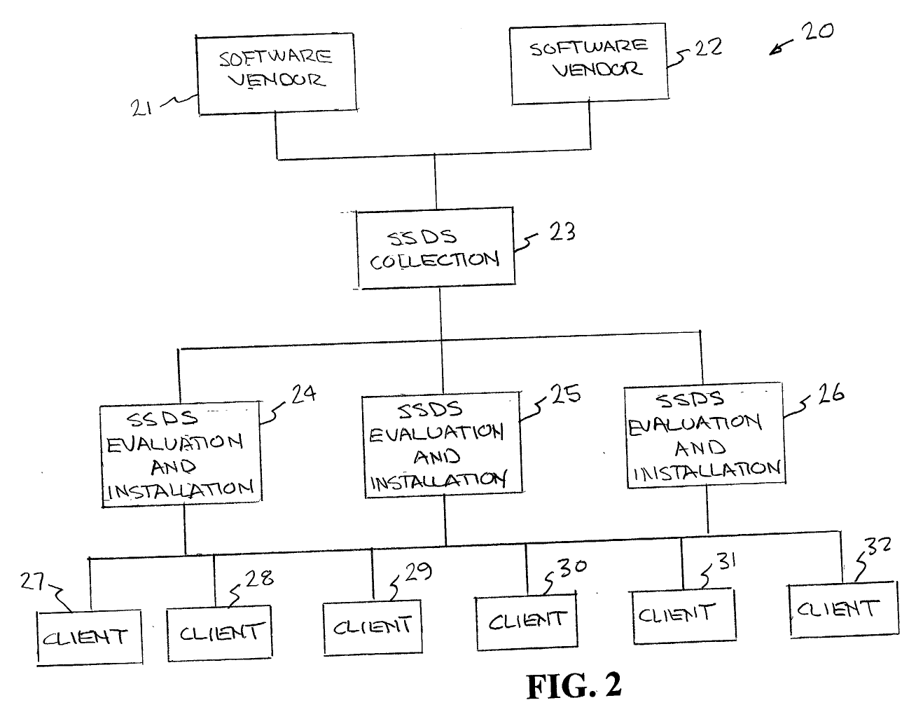

In addition to the one or two patch collection services, one system per subnet or organization would be configured to support the evaluation and installation of patches on a subset of the company's computer systems. The number of systems performing the evaluation and installation service would be determined by administrative domains similar to centralized services (e.g., backups, mail). As shown in FIG. 2, these systems would get their patches from the centralized patch collectors. The system shown in FIG. 2 is generally designated by the reference numeral 20. Vendor 21 and vendor 22 are shown; however, it is to be understood that any number of vendors can be included. The centralized patch collection service 23 monitors the vendor sites for the latest patches and stores them in a non-vendor specific format. The evaluation and installation service 24, evaluation and installation service 25, and evaluation and installation service 26 are shown; however, it is to be understood that any number of evaluation and installation services can be included. Client 27, client 28, client 29, client 30, client 31, and client 32, are shown; however, it is to be understood that any number of clients can be included. The SafePatch Client software would be installed on all systems in the network. This configuration distributes the workload and reduces duplication of effort.

In addition to the one or two patch collection services, one system per subnet or organization would be configured to support the evaluation and installation of patches on a subset of the company's computer systems. The number of systems performing the evaluation and installation service would be determined by administrative domains similar to centralized services (e.g., backups, mail). These systems would get their patches from the centralized patch collectors as shown in FIG. 2. The SafePatch Client software would be installed on all systems in the network. This configuration distributes the workload and reduces duplication of effort.

SafePatch Evaluation:

SafePatch performs system-level evaluations to ensure all object modules belonging to an operating system are authentic and patched to the latest revision. An authentic object module is one that corresponds to a vendor's object module. The evaluation process will check to ensure the security patches for a corresponding OS type and version are installed on the target system. Only those objects for which the vendor has issued patches will be checked.

Assumptions:

1. One patch specification definition file will be generated for each vendor-distributed patch. At a minimum, every object contained within a vendor issued patch will be described within at least one patch specification file. This provided SafePatch with the ability to determine whether an object is authentic and up-to-date.

2. Patches collected and processed by SafePatch are categorized as security and/or Y2K patches.

3. There are 5 types of patches:

1. Patches with no object modules. These patches usually require changes in permissions, group, or ownership on files.

2. Patches that replace executables.

3. Patches that add new files to a system.

4. Patches that include packages that are currently not installed on a system.

5. Patches that are related to the processor of a system.

The evaluation process can be summarized as follows.

1. Receive job.

2. Collect patches and objects to be considered.

3. Get object information from target system.

4. Iterate over the patch specifications chronologically starting from the latest released patch. Categorize the patch status into one of the following.

| | |
|---|---|
| installed | All objects referenced in the patch specification are |
| | found on the target system and their checksums |
| | match those found within the most recent patch |
| | revision. |
| superseded | A patch specification is superseded when all |
| | objects on are found within a more recent patch |
| | specifications. |
| not tested | One or more objects referenced in the patch |
| | specification are missing on the target machine. |
| needed | A patch specification is needed when one or more |
| | objects within the patch specification need to be |
| | installed on the target system. Through deduction, |
| | if a patch specification is not installed, superseded, |
| | or not tested, then the patch corresponding to this |
| | specification needs to be installed on the target |
| | machine. |
| not installed | The package associated with this object is not |
| | installed on the target system. |
| unknown | The checksum of an object located on a target |
| | machine does not match the checksum within any |
| | of the patch specification files. |

5 . Generate report.

The following details the process in a top down fashion. Job Controller:

1. Receive a message from the scheduler to evaluate one or more target systems. Instantiate a job object to manage the execution of this job.

2. For each target system specified in the job, create a TargetJob object to perform the evaluation process.

TargetJob Evaluation Process:

1. Connect to target system.

If the target system does not immediately respond, wait 2 minutes and try again for 10 times. If still not responding, generate a report containing an error message.

2. Obtain target product information (OS type, version, and architecture).

3. From the Patch Specification Database, collect all patches corresponding to the target OS type, version, and architecture.

4. Order all patch specifications by release date. Patches with the latest release date should be first.

5. Create a list of unique file objects referenced in the collected patch specifications. Uniqueness is determined by object name. Also create a list of unique directory objects referenced in the collected patch specifications.

6. Generate a patch zero (P₀) object containing the intersection of the unique lists (defined in step 5) and the object files and directories that originated from the initial OS release. Add this patch zero object to the end of the patch list.

7. Request from the target system the checksums, ownership, and access control list for all file objects on the unique file list. The target system should indicate that the file object was not found or if found return the object information. Also request from the target system the ownership and access control list for all directory objects on the unique directory list.

8. Starting with the latest patch specification, iterate over all file objects within the specifications and update the following table:

| | object 1 | object 2 | . . . |
|---|---|---|---|
| is_latest_installed | | | |
| ps_latest_obj | | | |
| ps_matching_xsum | | | |
| owner_match | | | |
| acl_match | | | |

If object.is_latest_installed is blank then this is the first encounter of this object.

If checksum in patch specification matches checksum of object on target then

object.is_latest_installed = True
object.ps_latest_obj = current patch id
object.ps_matching_xsum = current patch id
If patch ownership matches the target's ownership,
owner_match = True
If patch acl match the target's acl, acl_match = True

else

object.is_latest_installed = False
object.ps_latest_obj = current patch id

endif

Else if object.is_latest_installed = True then

do nothing.

Else if object.is_latest_installed = False then

If checksum in patch specification matches checksum of object on target then:

object.ps_matching_xsum = current patch id
If patch ownership matches the target's ownership, owner_match =
True
If patch acl match the target's acl, acl_match = true

All blank ps_matching_xsum fields in the table should be set to Unknown.

9. Iterate over all patch specification starting with the latest released patch. Tag each one of the file objects in the patch specification with one of the following codes:

| | |
|---|---|
| Not_Set | object.ps_matching_xsum is Not_Set indicating that |
| | the object could not be found or read. |
| U | object.ps_matching_xsum is blank meaning the |
| | object's checksum does not match any patch |
| | specification object checksums. The object is |
| | unknown. |
| < | current patch specification id |
| | <object.ps_matching_xsum : an object more recent |
| | than the object listed in the current patch specification |
| | has been installed on the target. The object in the |
| | current patch specification is obsolete. |
| = | object.ps_matching_xsum = current patch specification |
| | id : the object in the current patch specification |
| | matches the object on the target. The object is installed. |
| > | current patch specification id > |
| | object.ps_matching_xsum : an object older than the |
| | object listed in the current patch specification has |
| | been installed on the target. The object in the current |
| | patch specification is needed. |

| | |
|---|---|
| Pkg_not_installed | the current patch specification belongs to a |
| | package not installed on the target system. |

Determidne patch specification status by looking at the tags on each of the file objects referenced by the patch specification. A patch is installed if one or more file object tags are=(installed) and zero or more file object tags are<(obsolete) or if the total number of file object tags in a patch are equal to the number of installed objects and the number of objects with the package not installed, the patch is considered installed.

A patch is superseded if all object tags are either obsolete or the package is not installed.

A patch is not tested if any object tags are Not_Set. Otherwise the patch is needed (should be installed). This includes patches with unknown objects.

10. Now test the settings on the directories of installed patches. Iterate over each directory in each installed patch specifications starting with the latest released patch. Update the following table:

| | dir 1 | dir 2 | . . . |
|---|---|---|---|
| Is_latest_install | | | |
| Dir_latest_obj | | | |
| owner_match | | | |
| acl_match | | | |

If object.ps_latest_obj is blank then this is the first encounter of this directory object.

object.Dir_latest_obj = current patch id
If patch ownership matches the target's ownership, owner_match =
true
If patch acl match the target's acl, acl_match = true

11. SafePatch Recommended Actions: Determine which patches should be installed. Create two lists: needed_list and not_needed_list. The needed_list will contain those patch specifications that need to be installed on the target system. The patch specifications on this list are those with a status of needed or installed. The not_needed_list will contain those patch specification that do not need to be installed. Below are the different scenarios where a needed patch may not need to be installed.

a. Patches that are revisions of other more recent patches do not need to be installed. Also some needed patches may not be needed if the union of other needed patches supersedes it (case 4). If ALL objects in a patch on the needed_list are NOT the latest objects (check ps_latest_obj), then the patch is not needed and is added to the not_needed_list.

b. Needed patches are then checked against the entries within the vendor specific exceptions file.

1. Remove patches specified as ignore records from the needed list. This may include a single revision or multiple revisions.

2. Reorder the needed patch list moving the patches required by patches above the patches requiring them in the needed list.

3. Remove any patches from the needed list if it is currently installed on the remote machine.

12. Generate report:

a. All patches on the needed_list need to be installed.

b. Report any ad and ownership changes that differ from what the vendor recommends. To determine changes to acl and ownership iterate through patch specifications. If the patch specification is installed and acl_match field is false then report ace change and the suggested acl. If the patch specification is installed and the owner_match field is false then report ownership change and the suggested owner.

c. List patches by status: installed, superseded, needed, and not_tested. All references to the patch specification with the original product release (e.g., Solaris 2.5) specification file should be removed from the list.

d. List objects by file and directory. For file objects include object status: installed, obsolete, unknown, known bad, or missing.

e. List warnings on each directory or file object with incorrect ad or owner settings.

Examples:

Case 1: System with unidentified objects

For case 1 there are 5 patches (P₁, P_{2.1}, P_{2.2}, P₃, P₄) plus the original distribution patch (P₀). object_c of patch P₃ is installed on the target system. object_b exists but is not authentic (unknown xsum); object_d can't be found.

| object/patch | P₀ | P₁ | P_{2.1} | P_{2.2} | P₃ | P₄ |
|---|---|---|---|---|---|---|
| object_a | O | O | O | O | | |
| object_b | O | O | O | O | O | |
| object_c | O | O | | | Ø | |
| object_d | O | O | | | | O |

O = indicates object is part of a patch but not installed on target system.
Ø = indicates object is part of a patch and is installed on target system.
= indicates object is not part of the patch.

The first step in the evaluation process is to fill out the following table by iterating over each object in each patch specification starting with the latest released patch.

| | object_a | object_b | object_c | object_d |
|---|---|---|---|---|
| is_latest_installed | N | N | I | N |
| ps_latest_obj | 2.2 | 3 | 3 | 4 |
| ps_matching_xsum | 1 | U | 3 | Not_Set |

The next step is to iterate over each patch specification tagging each of the objects.

| | | | | | Patch |
|---|---|---|---|---|---|
| Patch/Object | object_a | object_b | object_c | Object_d | Status |
| P₀ | Installed | Unknown | < | Not_Tested | Not |
| | | | | | Tested |
| P₁ | Needed | Unknown | < | Not_Tested | Not |
| | | | | | Tested |
| P_{2.1} | Needed | Unknown | | | Needed |
| P_{2.2} | Needed | Unknown | | | Needed |
| P₃ | | Unknown | = | | Needed |
| P₄ | | | | Not_Tested | Not |
| | | | | | Tested |

The report should indicate that P_{2.2}, P₃ needs to be installed. P₀, P₁, and P₄ have not been tested.

Case 2: Some patches improperly installed

For case 2 there are 5 patches (P₁, P_{2.1}, P_{2.2}, P₃, P₄) plus the original distribution patch (P₀). Patches P₀, and P_{2.2} have been installed. object_b of patch P₃ has been installed on the target system.

| object/patch | P₀ | P₁ | P_{2.1} | P_{2.2} | P₃ | P₄ |
|---|---|---|---|---|---|---|
| object_a | O | O | O | Ø | | |
| object_b | O | O | O | Ø | O | |
| object_c | O | O | | | Ø | |
| object_d | Ø | O | | | | O |

O = indicates object is part of a patch but not installed on target system.
Ø = indicates object is part of a patch and is installed on target system.
= indicates object is not part of the patch.

The first step in the evaluation process is to fill out the following table by iterating over each object in each patch specification starting with the latest released patch.

| | object_a | object_b | object_c | object_d |
|---|---|---|---|---|
| is_latest_installed | I | N | I | N |
| ps_latest_obj | 2.2 | 3 | 3 | 4 |
| ps_matching_xsum | 2.2 | 2.2 | 3 | 0 |

The next step is to iterate over each patch specification tagging each of the objects.

| Patch/ | | | | | Patch |
|---|---|---|---|---|---|
| Object | object_a | object_b | object_c | object_d | Status |
| P₀ | < | < | < | = | Installed |
| P₁ | < | < | < | > | Needed |
| P_{2.1} | < | < | | | Superseded |
| P_{2.2} | = | = | | | Installed |
| P₃ | | > | = | | Needed |
| P₄ | | | | > | Needed |

The report should indicate that P₃ and P₄ need to be installed.

Case 3: System up-to-date

For case 3 there are 5 patches (P₁, P_{2.1}, P_{2.2}, P₃, P₄) plus the original distribution patch (P₀). Patches P₁, P_{2.2}, P₃, and P₄ have been installed. This system is up-to-date.

| object/patch | P₀ | P₁ | P_{2.1} | P_{2.2} | P₃ | P₄ |
|---|---|---|---|---|---|---|
| object_a | O | O | O | Ø | | |
| object_b | O | O | O | O | Ø | |
| object_c | O | O | | | Ø | |
| object_d | O | Ø | | | | Ø |

O = indicates object is part of a patch but not installed on target system.
Ø = indicates object is part of a patch and is installed on target system.
= indicates object is not part of the patch.

The first step in the evaluation process is to fill out the following table by iterating over each object in each patch specification starting with the latest released patch.

| | object_a | object_b | object_c | object_d |
|---|---|---|---|---|
| is_latest_installed | I | I | I | I |
| ps_latest_obj | 2.2 | 3 | 3 | 4 |
| ps_matching_xsum | 2.2 | 3 | 3 | 4 |

The next step is to iterate over each patch specification tagging each of the objects.

| Patch/ | | | | | Patch |
|---|---|---|---|---|---|
| Object | object_a | object_b | object_c | object_d | Status |
| P₀ | < | < | < | < | Superseded |
| P₁ | < | < | < | < | Superseded |
| P_{2.1} | < | < | | | Superseded |
| P_{2.2} | = | < | | | Installed |
| P₃ | | = | = | | Installed |
| P₄ | | | | = | Installed |

From this table we determine that P₀ and P₁ have been superseded. P_{2.1} is superseded and P_{2.2} is installed. P₃ has been installed. The report should indicate that nothing needs to be done.

Case 4: System never been patched

For case 4 there are 5 patches (P₁, P_{2.1}, P_{2.2}, P₃, P₄) plus the original distribution patch (P₀). Patch P₀ has been installed. This system is out of date.

| object/patch | P₀ | P₁ | P_{2.1} | P_{2.2} | P₃ | P₄ |
|---|---|---|---|---|---|---|
| object_a | Ø | O | O | O | | |
| object_b | Ø | O | O | O | O | |
| object_c | Ø | O | | | O | |
| object_d | Ø | O | | | | O |

O = indicates object is part of a patch but not installed on target system.
Ø = indicates object is part of a patch and is installed on target system.
= indicates object is not part of the patch.

The first step in the evaluation process is to fill out the following table by iterating over each object in each patch specification starting with the latest released patch.

| | object_a | object_b | object_c | object_d |
|---|---|---|---|---|
| is_latest_installed | N | N | N | N |
| ps_latest_obj | 2.2 | 3 | 3 | 4 |
| ps_matching_xsum | 0 | 0 | 0 | 0 |

The next step is to iterate over each patch specification tagging each of the objects.

| | | | | | Patch |
|---|---|---|---|---|---|
| Patch/Object | object_a | object_b | object_c | object_d | Status |
| P₀ | = | = | = | = | Installed |
| P₁ | > | > | > | > | Needed |
| P_{2.1} | > | > | | | Needed |
| P_{2.2} | > | > | | | Needed |
| P₃ | | > | > | | Needed |
| P₄ | | | | > | Needed |

The report should indicate that P_{2.2}, P₃, and P₄ needs to be installed in this order.

Case 5: System out of date

For case 5 there are 5 patches (P₁, P_{2.1}, P_{2.2}, P₃, P₄) plus the original distribution patch (P₀). Patches P₁ and P_{2.1} have been installed. This system is out of date.

| object/patch | P₀ | P₁ | P_{2.1} | P_{2.2} | P₃ | P₄ |
|---|---|---|---|---|---|---|
| object_a | ◯ | ◯ | Ø | ◯ | | |
| object_b | ◯ | ◯ | Ø | ◯ | ◯ | |
| object_c | ◯ | Ø | | | ◯ | |
| object_d | ◯ | Ø | | | | ◯ |

◯ = indicates object is part of a patch but not installed on target system.
Ø = indicates object is part of a patch and is installed on target system.
= indicates object is not part of the patch.

The first step in the evaluation process is to fill out the following table by iterating over each object in each patch specification starting with the latest released patch.

| | object_a | object_b | object_c | object_d |
|---|---|---|---|---|
| is_latest_installed | N | N | N | N |
| ps_latest_obj | 2.2 | 3 | 3 | 4 |
| ps_matching_xsum | 2.1 | 2.1 | 1 | 1 |

The next step is to iterate over each patch specification tagging each of the objects.

| Patch/ | | | | | Patch |
|---|---|---|---|---|---|
| Object | object_a | object_b | object_c | object_d | Status |
| P₀ | < | < | < | < | Superseded |
| P₁ | < | < | = | = | Installed |
| P_{2.1} | = | = | | | Installed |
| P_{2.2} | > | > | | | Needed |
| P₃ | | > | > | | Needed |
| P₄ | | | | > | Needed |

The report should indicate that P_{2.2}, P₃ then P₄ should been installed in this order.

Case 6: Multiple revisions

For case 6 there are 5 patches (P₁, P_{2.1}, P_{2.2}, P₃, P₄) plus the original distribution patch (P₀). Patches P₁, P₃ and P₄ have been installed. This system needs older patches to be installed that will clobber newer installed patches.

| object/patch | P₀ | P₁ | P_{2.1} | P_{2.2} | P₃ | P₄ |
|---|---|---|---|---|---|---|
| object_a | ◯ | Ø | ◯ | ◯ | | |
| object_b | ◯ | ◯ | ◯ | ◯ | Ø | |
| object_c | ◯ | ◯ | | | Ø | |
| object_d | ◯ | ◯ | | | | Ø |

◯ = indicates object is part of a patch but not installed on target system.
Ø = indicates object is part of a patch and is installed on target system.
= indicates object is not part of the patch.

The first step in the evaluation process is to fill out the following table by iterating over each object in each patch specification starting with the latest released patch.

| | object_a | object_b | object_c | object_d |
|---|---|---|---|---|
| is_latest_installed | N | I | I | I |
| ps_latest_obj | 2.2 | 3 | 3 | 4 |
| ps_matching_xsum | 1 | 3 | 3 | 4 |

The next step is to iterate over each patch specification tagging each of the objects.

| Patch/ | | | | | Patch |
|---|---|---|---|---|---|
| Object | object_a | object_b | object_c | object_d | Status |
| P₀ | < | < | < | < | Superseded |
| P₁ | = | < | < | < | Installed |
| P_{2.1} | > | < | | | Needed |
| P_{2.2} | > | < | | | Needed |
| P₃ | | = | = | | Installed |
| P₄ | | | | = | Installed |

The report should indicate that P_{2.2} then P₃ should been installed in this order.

Case 7: Wrong owners

For case 7 there are 5patches (P₁, P_{2.1}, P_{2.2}, P₃, P₄) plus the original distribution patch (P₀). Patches P_{2.2}, P₃ and P₄ have been installed except object_b in P₃ has a different owner than on the target system.

| object/patch | P₀ | P₁ | P_{2.1} | P_{2.2} | P₃ | P₄ |
|---|---|---|---|---|---|---|
| object_a | ◯ | ◯ | ◯ | Ø | | |
| object_b | ◯ | ◯ | ◯ | ◯ | Ø | |
| object_c | ◯ | ◯ | | | Ø | |
| object_d | ◯ | ◯ | | | | Ø |

◯ = indicates object is part of a patch but not installed on target system.
Ø = indicates object is part of a patch and is installed on target system.
= indicates object is not part of the patch.

The first step in the evaluation process is to fill out the following table by iterating over each object in each patch specification starting with the latest released patch.

| | object_a | object_b | object_c | object_d |
|---|---|---|---|---|
| is_latest_installed | I | U | I | I |
| ps_latest_obj | 2.2 | 3 | 3 | 4 |
| ps_matching_xsum | 2.2 | 3 | 3 | 4 |

The next step is to iterate over each patch specification tagging each of the objects.

| Patch/ | | | | | |
|---|---|---|---|---|---|
| Object | object_a | object_b | object_c | object_d | Patch Status |
| P₀ | < | < | < | < | Superseded |
| P₁ | < | < | < | < | Superseded |
| P_{2.1} | < | < | | | Superseded |
| P_{2.2} | = | < | | | Installed |
| P₃ | | = | = | | Installed |
| P₄ | | | | = | Installed |

The report should give out a warning about an incorrect owner setup in P₃.

Case 8: Wrong Access Control List Setup

For case 7 there are 5 patches (P₁, P_{2.1}, P_{2.2}, P₃, P₄) plus the original distribution patch (P₀). Patches P_{2.2}, P₃ and P₄ have been installed except object_c in P₃ has a different group and object_d in P₄ has different permissions than the target system.

| object/patch | P₀ | P₁ | P_{2.1} | P_{2.2} | P₃ | P₄ |
|---|---|---|---|---|---|---|
| object_a | ◯ | ◯ | ◯ | Ø | | |
| object_b | ◯ | ◯ | ◯ | ◯ | Ø | |
| object_c | ◯ | ◯ | | | Ø | |
| object_d | ◯ | ◯ | | | | Ø |

◯ = indicates object is part of a patch but not installed on target system.
Ø = indicates object is part of a patch and is installed on target system.
= indicates object is not part of the patch.

The first step in the evaluation process is to fill out the following table by iterating over each object in each patch specification starting with the latest released patch.

| | object_a | object_b | object_c | object_d |
|---|---|---|---|---|
| is_latest_installed | I | U | I | U |
| ps_latest_obj | 2.2 | 3 | 3 | 4 |
| ps_matching_xsum | 2.2 | 3 | 3 | 4 |

The next step is to iterate over each patch specification tagging each of the objects.

| Patch/ | | | | | |
|---|---|---|---|---|---|
| Object | object_a | object_b | object_c | object_d | Patch Status |
| P₀ | < | < | < | < | Superseded |
| P₁ | < | < | < | < | Superseded |
| P_{2.1} | < | < | | | Superseded |
| P_{2.2} | = | < | | | Installed |
| P₃ | | = | = | | Installed |
| P₄ | | | | = | Installed |

The report should give out a warning about an incorrect group setup in P₃ and incorrect permissions in P₄.

Case 9: Not Patched With Wrong Owner

This case is the same as test case 4 but object c has different owner than recommended.

Case 10: Not Patched With Wrong ACL

This case is the same as test case 5 but object a has different access control list than recommended.

Case 11 is the same as case 1, but a new file has been added to Patch 5.

The object /usr/bin/du should be UNKNOWN and Patch 5 is Needed.

NOTE: to setup this test case you need to move patch 5 to the database directory

WARNING: The SetupTestCase11 script moves /usr./bin/su to /usr/bin/su.save.

This file needs to be moved back after the test is completed.

The flow chart, FIG. 1, represents logic incorporated into SafePatch to handle Sun patch anomalies that have been identified to date.

The following represents two test cases in which the algorithm should pass. (Note: No ignore patches were included due to their simplicity.)

| | | |
|---|---|---|
| Needed Vector | Exceptions File | New PLV |

Test Scenario #1:

| | | |
|---|---|---|
| E-1 | A requires B | B-4 |
| C-2 | C requires A | A-3 |
| A-3 | E requires A | E-1 |
| B-4 | | C-2 |
| D-5 | | D-5 |

Test Scenario #2:

| | | |
|---|---|---|
| A-1 | A requires B | B-2 |
| B-2 | A requires D | D-4 |
| C-3 | | A-1 |
| D-4 | | C-3 |

Automated information processing is destined to play an increasingly important role in our lives, and it will become critically important to assure trust in these information systems. SafePatch can fulfill a central role in this assurance with a uniform solution to the automated authentication and maintenance of system software. SafePatch will serve to protect against threats to information resources and provide a high level of trust to the users of a system. SafePatch is a software system capable of accomplishing one or more of the following capabilities:

1. Determining which patches have been applied to a system.

2. Determining which patches should be or should have been applied to a system.

3. Collecting patches from most vendors by downloading them from the vendor's ftp sites; interpreting the operating system type, version and architecture the patch applies to; how much memory and disk space is needed to install the patch; dependencies on other layered products, patches, or upgrades; and which files and directories are affected by the installation of a patch.

4. Installing and possibly backing out patches.

The present invention provides a computer-implemented method of secure distribution and installation of vendor software patches onto client systems. The method includes determining which vendor's patches have been applied to a system and installing vendor's patches on a system. The method includes determining which patches should be or should have been applied to a system. The method includes backing out undesirable patches from a system. The method includes collecting patches from most vendors by downloading them from the vendor's ftp sites. The method includes interpreting the operating system type. The method includes interpreting the operating system version. The method includes interpreting the operating system architecture the patch applies to. The method includes determining how much memory is needed to install said patch. The method includes determining how dependencies on other layered products affect the installation of a patch. The method includes determining how dependencies on other upgrades or patches affect the installation of a patch, determining which files are affected by the installation of a patch, and determining which directories are affected by the installation of a patch.

A prototype version of SafePatch and a draft SafePatch Users Manual were prepared and tested in May 1998. The prototype version was upgraded to SafePatch version 1.1. An upgraded version of SafePatch, version 1.2.1, provides automated analysis, distribution, notification, and installation of security and Y2K patches on network-based computer systems. SafePatch 1.2.1 determines what patches need to be installed. For the patches that are installed, SafePatch 1.2.1 checks the permissions and ownership of the files referenced in the patch and ensures that the system software is authentic. SafePatch is composed of two components: (1) Patch Server and (2) Vendor Server. Currently, SafePatch 1.2.1 detects patch deficiencies, distributes needed patches, and optionally installs the patches on network-based computer systems. SafePatch 1.2.1 is supported on Sun systems running Solaris 2.5.1 or newer and RedHat Linux systems running versions 6.0 or newer.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The invention claimed is:

1. A computer-implemented method of secure installation of vendor's software patches on client's systems, comprising the steps of:
determining which of said software patches should be applied to said client's systems
collecting said software patches from said vendors by downloading them from said vendor's ftp sites
distributing said software patches to said client's systems
installing said software patches

2. The computer-implemented method of secure installation of vendor's software patches on client's systems of claim 1, include steps of:
determining which software patches should be applied to said client's systems
collecting said software patches from said vendors by downloading them from said vendor's ftp sites
distributing said software patches to said client's systems
Interpreting which files will be affected by the installation of said software patches
interpreting which directories will be affected by the installation of said software patches
installing said software patches

3. The computer-implemented method of secure installation of vendor's software patches on client's systems of claim 1, include steps of:
determining which software patches should be applied to said client's systems
collecting said software patches from said vendors by downloading them from said vendor's ftp site
distributing said software patches to said client's systems
interpreting which files and directories will be affected by the installation of said software patches
interpreting how much memory and disk space is needed to install software upgrades and installing said software patches

4. The computer-implemented method of secure installation of vendor's software patches on client's systems of claim 1, include steps of:
determining which software patches should be applied to said client's systems
collecting said software patches from said vendors by downloading them from said vendor's ftp sites
distributing said software patches to paid client's systems
interpreting the operating system type, version and architecture said software patches apply to
interpreting which files and directories will be affected by the installation of said software patches
interpreting how much memory and disk space is needed to install said software patches
interpreting dependencies on other layered products
installing said software patches

5. The computer-implemented method of secure installation of vendor's software patches on client's systems of claim 1, include steps of:
determining which software patches should be or should have been applied to said client's systems
collecting said software patches from said vendors by downloading them from said vendor's ftp sites
distributing said software patches to said client's systems
interpreting the operating system type, version and architecture said software patches apply to
interpreting which files and directories are affected by the installation of said software patches
interpreting how much memory and disk space is needed to install said software patches
interpreting dependencies on other layered products
installing said software patches
backing-out said software patches that have been applied to said client's systems

6. A computer-implemented method of secure distribution of vendor's upgrades and patches to client's systems, comprising:
determining which of vendor's upgrades and patches have been applied to client's systems
determining which said software upgrades and patches should be or should have been applied to said clients systems

7. The computer-implemented method of secure distribution of vendor's upgrades and patches of claim 6, include:
collection of said patches and upgrades from said vendor's and downloading said patches and upgrades to client systems

8. The computer-implemented method of secure distribution of vendor's upgrades and patches of claim 7, include the step of:
interpreting the operating system type

9. The computer-implemented method of secure distribution of vendor's upgrades and patches of claim 7, include the step of:
interpreting the operating system version

10. The computer-implemented method of secure distribution of vendor's upgrades and patches of claim 7, include the step of:
interpreting the operating system architecture the patch applies to

11. The computer-implemented method of secure distribution of vendor's upgrades and patches of claim 7, include the step of:
determining how much memory is needed to install said patch and upgrades

12. The computer-implemented method of secure distribution of vendor's upgrades and patches of claim 7, include the step of:
determining how dependencies on other layered products affect the installation of said patches and upgrades

13. The computer-implemented method of secure distribution of vendor's upgrades and patches of claim 7, include the step of:
determining how dependencies on other patches, or software upgrades affect the installation of a patch

14. The computer-implemented method of secure distribution of vendor's upgrades and patches of claim 7, include the step of:
determining how dependencies on other software upgrades affect the installation of a patch

15. The computer-implemented method of secure distribution of vendor's upgrades and patches of claim 7, include the step of:
determining which files will be affected by the installation of a patch

16. The computer-implemented method of secure distribution of vendor's upgrades and patches of claim 7, include the step of:
determining which directories will be affected by the installation of a patch

17. The computer-implemented method of secure distribution of vendor's upgrades and patches of claim 7, include the step of:
Checking the permissions and ownership of the files referenced in the patch and ensuring that the system software is authentic
